(19) United States
(12) Patent Application Publication
(10) Pub. No.: US 2023/0382365 A1
(43) Pub. Date: Nov. 30, 2023

(54) METHOD FOR OPERATING A VEHICLE

(71) Applicant: AUDI AG, Ingolstadt (DE)

(72) Inventor: Erdal ACIKGOEZ, Reichertshofen (DE)

(21) Appl. No.: 18/323,163

(22) Filed: May 24, 2023

(30) Foreign Application Priority Data
May 25, 2022 (DE) 102022113196.3

(51) Int. Cl. B60W 20/10; B60W 10/06; B60W 10/08; B60W 50/14

(52) U.S. Cl. CPC B60W 20/10; B60W 10/06; B60W 10/08; B60W 50/14

(57) ABSTRACT

The disclosure relates to a method of operating a vehicle including at least two drive units that operates based on two different energy-involving drive principles, including at least one internal combustion engine that operates based on a combustion engine drive principle and at least one electric machine that operates based on an electromechanical drive principle, wherein one of the two different drive principles is utilized during each drive cycle based on a length of a distance traveled by the vehicle during the drive cycle as a distance-dependent parameter and a length of a time interval during which the drive cycle is utilized as a time-dependent parameter, and one of the at least two drive units is activated to carry out a primary one of the two different drive principles during a current drive cycle, while a second one of the at least two drive units is deactivated.

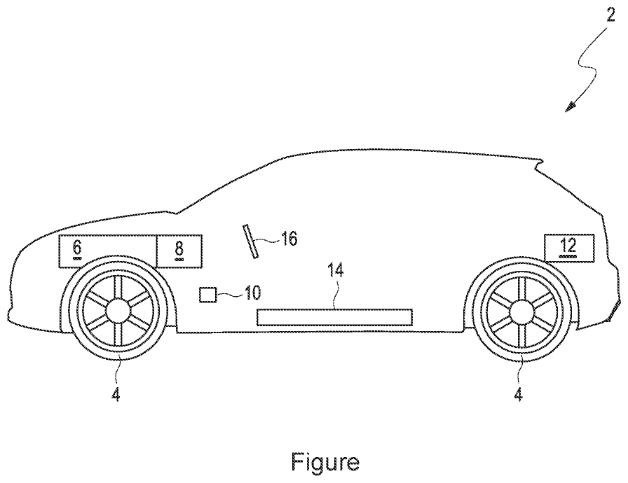

### BACKGROUND

### Technical Field

The disclosure relates to a method for operating a vehicle and a drive system for a vehicle.

### Description of the Related Art

A hybrid vehicle can be driven by an internal combustion engine and/or an electric machine.

Publications CN 108422993 A and WO 2007/074367 A2 each describe a hybrid vehicle and a control method for this.

A hybrid vehicle is also known from publication JP 2009/143563 A.

Against this background, embodiments of the disclosure provide a method and a drive system that enable effective driving of a hybrid vehicle.

### BRIEF SUMMARY

The method according to the disclosure is intended for the operating, i.e., generally the driving or propelling of a vehicle, such as a hybrid motor vehicle, having at least two drive units for carrying out two different energy-involving drive principles. At least one internal combustion engine as the combustion engine drive unit is designed to carry out a combustion engine drive principle. Moreover, at least one electric machine as the electromechanical or electric machine drive unit is designed to carry out an electromechanical or electric machine drive principle. In the method, each time during a drive cycle only one of the two drive principles is utilized or used for the vehicle, i.e., either only the internal combustion engine or only the electromechanical drive principle. Each drive cycle occurs for one of the two drive principles in dependence on the length of a time interval as a time-dependent parameter between two moments of time, i.e., the start time and the end time, during which the drive cycle is utilized, and in dependence on the length of a distance as a distance-dependent parameter, which is or will be and/or has been traveled by the vehicle during the drive cycle between the start time and the end time. At the start time for a current drive cycle, only at least one drive unit is switched on or activated to carry out a primary one of the two drive principles, whereas at least one drive unit is deactivated or switched off to carry out a secondary one of the two drive principles. Moreover, a maximum value and a tolerance value are provided for one of the parameters, i.e., either for the distance-dependent or for the time-dependent parameter, and a limit value for this one of the two parameters corresponds to the maximum value minus the tolerance value. Moreover, at a current moment of time after the start time during the currently performed drive cycle, usually prior to the automatically scheduled end time in one embodiment, this one of the two parameters on which the current drive cycle is dependent is detected and compared to the limit value provided for this. If this one of the two parameters reaches or has reached the limit value provided for this during the currently performed drive cycle, a signal is sent that the at least one drive unit for performing the primary drive principle is switched off or deactivated if this one parameter has reached or will reach the maximum value provided for this, and instead the at least one drive unit for carrying out the secondary drive principle is switched on or activated, usually during the next successive drive cycle after the current drive cycle.

It is possible for the current drive cycle being performed to have been started by the driver of the vehicle at the start time, in which case the driver either selects and/or dictates only the combustion engine drive principle or alternatively only the electromechanical drive principle. In one embodiment of the method, it is possible for the driver to only select the combustion engine drive principle for the current drive cycle and the at least one internal combustion engine is switched on or activated in order to carry out the combustion engine drive principle as the primary drive principle, while the at least one electric machine is or remains switched off or deactivated to carry out the electromechanical drive principle as the secondary drive principle. Alternatively, it is possible for the driver to select only the electromechanical drive principle for the current drive cycle and only the at least one electric machine is switched on or activated to carry out the electromechanical drive principle as the primary drive principle, while the at least one internal combustion engine is switched off or deactivated to carry out the combustion engine drive principle as the secondary drive principle.

In the method, at the start time of the current drive cycle and during this, a controller of the vehicle monitors and detects the one parameter which is or has been selected from the two mentioned parameters at a respective current moment of time, every two of such moments of time occurring immediately one after the other in a definable interval of time. The tolerance value usually corresponds to a definable fraction, such as a single-digit percentage up to around 10% of the maximum value. It is also conceivable for the tolerance value to be 0, in which case the limit value corresponds to the maximum value.

The controller and/or an output device signals a switch between the two drive principles, in the present case promptly announced before reaching the maximum value
if as the parameter the length of the distance covered during the current drive cycle has reached the distance-dependent limit value provided for this at the particular current moment of time, or
if as the parameter the length of the time interval has reached the time-dependent limit value, as scheduled in one embodiment, during the current drive cycle at the particular current moment of time, starting from the start time.

Furthermore, it is possible for the vehicle to be moved into a safe position prior to the ending of the current drive cycle.

With the method, it is possible for the vehicle to switch from the combustion engine to the electromechanical drive principle or from the electromechanical to the combustion engine drive principle, if or as soon as the distance covered, for example in kilometers, or the time interval, for example in minutes, has reached the maximum value provided for this.

The drive system according to the disclosure is designed for a vehicle and comprises at least two drive units of the vehicle to carry out two different energy-involving drive principles and a controller, such as a control and/or regulation device of the vehicle, for controlling and/or regulating the method. At least one internal combustion engine is designed as a combustion engine drive unit to carry out a combustion engine drive principle. Furthermore, at least one electric machine is designed as an electromechanical drive unit to carry out an electromechanical drive principle. During a drive cycle, each time only one of the two drive principles is to be utilized or used, each drive cycle for one of the two drive principles being dependent on the length of a time interval as a time-dependent parameter and the length of a distance as a distance-dependent parameter which is covered by the vehicle during the drive cycle. The controller is designed to switch on or activate only at least one drive unit for a current drive cycle to carry out only one primary one of the two drive principles and to switch off or deactivate at least one drive unit to carry out a secondary one of the two drive principles. For only one of the parameters, a maximum value and a tolerance value are specified, while a limit value for this one parameter corresponds to the maximum value minus the tolerance value. Moreover, the controller is designed to detect and/or determine the one of the two parameters at a current moment of time during the currently performed drive cycle and to compare it with the limit value provided for this. If this one of the two parameters reaches the limit value provided for this during the currently performed drive cycle, so that the limit value is or has been accordingly reached, the controller is designed to signal that the at least one drive unit for carrying out the primary drive principle should be switched off or deactivated during the currently performed drive cycle at the current moment of time when this one parameter has reached or will reach the maximum value provided for this, and that instead the at least one drive unit for carrying out the secondary drive principle should be switched on or activated in the next, successive drive cycle.

The drive system and the vehicle have as their energy accumulator at least one battery or at least one storage battery for storing electric energy for the at least one electric machine and at least one tank for storing a fuel, such as a customary liquid hydrocarbon like gasoline or diesel, or alternatively for a gas, such as natural gas or hydrogen, for the at least one internal combustion engine. During a respective drive cycle, when carrying out the electromechanical drive principle, electric energy is converted from the at least one battery by the at least one electric machine into mechanical energy or chemical energy stored in the fuel is converted by the at least one internal combustion engine into mechanical energy for moving the drive wheels of the vehicle when the fuel is burned.

The drive system and the vehicle have an output device, such as a typical graphic person/machine interface, with a display field or display and/or a loudspeaker, which is adapted to informing the driver of the vehicle, optically and/or acoustically, in good time as to the upcoming ending of the current drive cycle prior to the upcoming ending of the current drive cycle and a switch from the primary to the secondary drive principle.

It is possible to carry out one embodiment of the method with one embodiment of the drive system. During the current drive cycle, the performance of the respective either combustion engine or alternatively electromechanical drive principle taking into account the provided maximum value for the one parameter is restricted and thus limited in dependence on distance or time, and upon reaching the maximum value a switch occurs between the drive principles, the driver being informed as to this with the output device as soon as the prescribed limit value has been reached.

With the method and the drive system, it is possible to limit the operation of one of the different drive units in a hybrid vehicle (PHEV, plug-in hybrid electric vehicle), usually the at least one internal combustion engines or the at least one electric machine.

With a usually software-supported execution function, which is used in one embodiment of the method and stored and/or implemented in the controller, it is exactly specified in the controller of the vehicle that the use of a respective drive unit, such as the internal combustion engine or alternatively the electric machine, and thus the performance of a combustion operation or the combustion engine drive principle or alternatively the performance of an electric drive or the combustion engine drive principle will be limited either in dependence on distance or time and not left to the discretion of the driver. The controller will automatically specify for the at least one internal combustion engine and/or the at least one electric machine that the drive system will be switched, after a particular distance traveled or covered or after the expiration of the defined time interval, each time only one of the two drive principles being used with the respective at least one drive unit, to the other respective drive principle, as a rule it must be so switched, and either the at least one internal combustion engine will be, or usually must be, replaced by the at least one electric machine, or alternatively the at least one electric machine by the at least one internal combustion engine.

Furthermore, the driver is provided at least one notice and/or warning with the acoustic and/or optical output device, such as a person/machine interface (MMI, man machine interface), telling him that the current drive cycle during which the primary drive principle is being used to propel the vehicle will be ended and a switch will be made to the alternative secondary drive principle and a further drive cycle will be performed with the secondary drive principle. The notifications from the controller will be displayed acoustically and/or optically via the output device. At first the driver will be warned by the output device. It is possible that the travel of the vehicle during the currently performed drive cycle to carry out the primary drive principle will be automatically ended and the vehicle brought to a forced stop after multiple, for example n times, and thus repeated warnings of the driver. Here, n is a definable natural number. Before the ending of the currently performed drive cycle it is provided that the vehicle will be automatically placed and/or steered by the driver in a safe position, it being possible to prompt the driver as to this via the output device.

In addition, in the case when the electromechanical drive principle is being performed during the current drive cycle as the primary drive principle with the at least one electric machine, the driver will be notified through the output device that a charging process should, or in general must, be undertaken or performed for the at least one battery.

Alternatively, in the case when the electromechanical drive principle is being performed during the current drive cycle as the primary drive principle with the at least one internal combustion engine, the driver will be notified through the output device that fuel should or in general must be filled in the at least one tank.

Thanks to a distance-dependent limitation of the current drive cycle, i.e., one dependent on the distance traveled in the current drive cycle, and/or a time limitation, it is possible in the case when the combustion engine drive principle is being used or implemented as the primary drive principle to obtain clarity as to emission which are caused by the vehicle and to further limit them when or as soon as the limit value or maximum value provided has been or will be reached for the distance traveled and/or the time interval. It can be defined how much emission at most is or can be caused by the vehicle in the electric motor drive principle.

A PHEV vehicle (Plug-in Hybrid Electric Vehicle) can cover and therefore drive for example a distance of around 100 km purely electrically or electromechanically during a drive cycle. Moreover, the PHEV vehicle can cover and therefore drive for example a distance of around 500 km to 600 km purely conventionally in combustion engine operation during an alternative drive cycle. It lies with the discretion of the driver how to drive the vehicle during the entire driving cycle, comprising at least one described drive cycle. Thus, in theory, the driver can drive the vehicle purely electrically up to 100%, while the driver regularly or repeatedly will carry out a charging process for the at least one battery, in order to build up a sufficient amount of electric energy in the at least one battery and maintain at least one minimum value specified for a state of charge of the at least one battery. Alternatively, the driver of the vehicle can in theory drive in 100% pure combustion operation.

With the method and the drive system proposed, the driver is provided with an indication for the control, such as the control and/or regulation, and/or for the driving or propulsion of the vehicle, i.e., for sole driving in the combustion engine or the electromechanical drive principle, on which the driver can and/or must rely. It is possible for the vehicle to be at least partly, or possibly fully, automatically controlled and/or regulated by the controller for a required switching between the two drive principles, at least temporarily, i.e., as soon as a switching from the first to the second drive principle has been decided upon, and during this time a manual steering of the vehicle by the driver is at least partly, or possibly fully restricted.

Of course, the features mentioned above and those yet to be explained below can be used not only in the particular indicated combination, but also in other combinations or standing alone, without leaving the scope of the present disclosure.

The disclosure is represented schematically in the drawing with the aid of embodiments and shall be described schematically and at length with reference to the drawing.

### BRIEF DESCRIPTION OF THE SEVERAL VIEWS OF THE DRAWINGS

The FIGURE shows in schematic representation a vehicle, having one embodiment of the drive system according to the disclosure for carrying out an embodiment of the method according to the disclosure.

### DETAILED DESCRIPTION

The vehicle 2 shown schematically in the FIGURE has multiple drive wheels 4. Moreover, it has an internal combustion engine 6 and an electric machine 8, a controller 10, and an output device 16 with a display field or a monitor screen and a loudspeaker, these components of the vehicle 2 also being configured as components of the drive system according to the disclosure.

Moreover, the vehicle 2 has a tank 12 or receptacle for storing a combustible fuel and a battery 14 for storing of electric energy. The vehicle 2 being a hybrid vehicle is designed to carry out both a combustion engine and an electromechanical drive principle. In the combustion engine drive principle, fuel from the tank 12 is burned by the internal combustion engine 6 and the chemical energy stored therein is converted into electric energy for the driving of the drive wheels 4. In the electromechanical drive principle, electric energy from the battery 14 is converted into electric energy to drive the drive wheels 4.

In the embodiment of the method, only one of the two drive principles is selected by the driver prior to the start time of a drive cycle, i.e., either only the combustion engine or only the electromechanical drive principle, and this is carried out as of the start time of the drive cycle. During this process, the controller 10 detects as a distance-dependent parameter the length of a distance covered by the vehicle 2 as of the start time and as a time-dependent parameter the time interval elapsing as of the start time. For one of the two parameters, a maximum value, i.e., a maximum allowed value, and a tolerance value or buffer value are specified. Moreover, it is also provided that a limit value for this one parameter corresponds to the maximum value minus the tolerance value. Moreover, the controller 10 monitors one of the two parameters and compares it to the corresponding distance-dependent or time-dependent limit value provided for this.

It is possible to set and/or dictate the maximum value, usually even before the start time, in dependence on the combustion engine or electromechanical drive principle selected and carried out exclusively during the drive cycle, and accordingly dependent on the drive principle. In addition, it is possible for the maximum value to be set and/or dictated, usually even before the start time, in dependence on the fill level of the fuel kept in the tank 12 or depending on a state of charge of the battery 14. The time or distance-dependent tolerance value further taken into account can likewise be dependent on the fill level or state of charge and likewise be set and/or dictated prior to the start time.

Thus, it is possible in one embodiment of the method to give prompt notice already at a current moment of time during the drive cycle being carried out as to the ending of the either combustion engine or electromechanical drive cycle at the anticipated and/or scheduled end time in one embodiment. Furthermore, a switching from the combustion engine to the electromechanical drive principle or a switching from the electromechanical to the combustion engine drive principle for the drive system is announced at the end time.

German patent application no. 102022113196.3, filed May 25, 2022, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method of operating a vehicle including at least two drive units that operate based on two different drive principles, including at least one internal combustion engine that operates based on a combustion engine drive principle and at least one electric machine that operates based on an electromechanical drive principle, wherein one of the two different drive principles is utilized during each drive cycle of a plurality of drive cycles based on a length of a distance traveled by the vehicle during the drive cycle as a distance-dependent parameter, and based on a length of a time interval during which the drive cycle is utilized as a time-dependent parameter, and a first one of the at least two drive units is activated to carry out a primary one of the two different drive principles and a second one of the at least two drive units is activated to carry out a secondary one of the two different drive principles, and a maximum value and a tolerance value are provided for one of the distance-dependent parameter and the time-dependent parameter, and a limit value for the one of the distance-dependent parameter and the time-dependent parameter corresponds to the maximum value minus the tolerance value, the method comprising:
comparing the one of the distance-dependent parameter and the time-dependent parameter during the current one of the drive cycles to the limit value, and
in response to determining that the one of the distance-dependent parameter and the time-dependent parameter has reached the limit value during the current one of the drive cycles, sending at least one signal that deactivates the first one of the at least two drive units during the current one of the drive cycles when the one of the distance-dependent parameter and the time-dependent parameter has reached the maximum value, and activates the second one of the at least two drive units.

2. The method according to claim 1, wherein the at least one internal combustion engine that operates based on the combustion engine drive principles is activated during the current one of the drive cycles, while the at least one electric machine that operates based on the electromechanical drive principle is deactivated.

3. The method according to claim 1, wherein the at least one electric machine that operates based on the electromechanical drive principle is activated during the current one of the drive cycles, while the at least one internal combustion engine that operates based on the combustion engine drive principle is deactivated.

4. The method according to claim 1, further comprising:
in response to determining that the length of the distance traveled during the current one of the drive cycles has reached the limit value, or the length of the time interval during the current one of the drive cycles has reached the limit value, sending at least one signal that switches from the primary one of the two different drive principles to the secondary one of the two different drive principles.

5. The method according to claim 1, further comprising:
moving the vehicle into a predetermined position prior to ending the current one of the drive cycles.

6. A drive system for a vehicle, the drive system comprising:
at least two drive units that operate based on two different energy-involving drive principles; and
a controller,
wherein the at least two drive units include at least one internal combustion engine that operates based on a combustion engine drive principle, and at least one electric machine that operates based on an electromechanical drive principle,
wherein one of the two different drive principles is utilized during each drive cycle of a plurality of drive cycles based on a length of a distance traveled by the vehicle during the drive cycle as a distance-dependent parameter, and based on a length of a time interval during which the drive cycle is utilized as a time-dependent parameter, and
wherein the controller, in operation, activates a first one of the at least two drive units to carry out a primary one of the two different drive principles and activates a second one of the at least two drive units to carry out a secondary one of the two different drive principles, and
wherein a maximum value and a tolerance value are provided for one of the distance-dependent parameter and the time-dependent parameter, and a limit value for the one of the distance-dependent parameter and the time-dependent parameter corresponds to the maximum value minus the tolerance value,
wherein the controller, in operation, compares the one of the distance-dependent parameter and the time-dependent parameter during a current one of the drive cycles to the limit value, and in response to determining that the one of the distance-dependent parameter and the time-dependent parameter has reached the limit value during the current one of the drive cycles, sending at least one signal that deactivates the first one of the at least two drive units to carry out the primary drive principle during the current one of the drive cycles when the one of the distance-dependent parameter and the time-dependent parameter has reached the maximum value, and activates the second one of the at least two drive units to carry out the secondary drive principle.

7. The drive system according to claim 6, further comprising:
at least one battery which, in operation, stores electric energy for the at least one electric machine and
at least one tank which, in operation, stores fuel for the at least one internal combustion engine.

8. The drive system according to claim 6, further comprising:
an output device which, in operation, notifies, a driver of the vehicle to an upcoming ending of the current one of the drive cycles prior to the upcoming ending of the current one of the drive cycles.
